(19) United States
(12) Patent Application Publication
(10) Pub. No.: US 2013/0300185 A1
(43) Pub. Date: Nov. 14, 2013

(54) MOBILITY DEVICE AND METHOD

(71) Applicant: Israel Zhavi, Zurit (IL)

(72) Inventor: Israel Zhavi, Zurit (IL)

(21) Appl. No.: 13/979,844

(22) PCT Filed: Jan. 24, 2012
(86) PCT No.: PCT/IL12/00036

§ 371 Date: Jul. 15, 2013

Related U.S. Application Data
(60) Provisional application No. 61/457,190, filed on Jan. 25, 2011.

(51) Int. Cl. B60B 15/26

(52) U.S. Cl. CPC B60B 15/26
USPC 301/47; 29/428

(57) ABSTRACT

A mobility device designed to be installed on a wheel of a vehicle comprises a device body extending longitudinally along a wheel axis and having a mechanism, the mechanism being provided with a scroll plate extending generally radially and having opposing inner and outer plate faces, and a plurality of stakes each extending generally radially away from a hub, the scroll plate having at least one spiral groove formed therein, the spiral groove being associated with, and driving the plurality of stakes reciprocably extending and/or retracting generally radially relative to the device body by a pin associated with each of the plurality of stakes and being engaged by the spiral groove of the scroll plate.

### FIELD OF THE DISCLOSURE

The present disclosure relates to mobility devices, and, in particular, mobility devices which may be removably mounted on one or more vehicle wheels, preferably on any wheel pair of a single axel, and which may be capable of transforming between a first position and a second position. In the first position, the mobility device may have as little as possible effect on the mobility of the vehicle associated therewith; in a second position, the mobility device may have a considerable effect on the mobility of the vehicle associated therewith; and, the mobility device may be continuously configurable throughout a range of position between the first and the second positions.

### BACKGROUND

Generally, simple means for enhancing the mobility, in particular traction, of a vehicle, are well-known. One such means for enhancing traction of the vehicle, particularly over ice and snow covered roads are removable chains (see, as an illustrative, nonbinding example, http://en.wikipedia.org/wiki/Snow_chains, disclosing, inter alia:
“Snow chains, or tire chains, are devices which are affixed to the tires of vehicles to provide superior traction when driving through snow and ice.
Snow chains are attached to the drive wheels of a vehicle. Chains are usually sold in pairs and must be purchased to match a particular tire size (tire diameter and tread width). Driving with chains will reduce fuel efficiency and can limit the speed of the automobile to approximately 30 mph (50 km/h).

### Deployment

In snowy conditions, transportation authorities may require snow chains to be fitted upon vehicles. This can apply to all vehicles, or those that lack certain motive combinations such as fourwheel drive and/or specific classifications of tires. Local requirements may be enforced at checkpoints. Snow chains should always be fitted to one or more drive axles of a vehicle, with varying requirements for dualtire or multidrivenaxle vehicles that range from one pair of tires on a driven axle to all tires on all driven axles being required to have snow chains fitted when conditions and/or signage require it.”

Further, the above cited reference teaches:

### Common Chain Failures

Driving too fast with chains. Maximum speed recommended in the chain's owner's manual is generally 30 to 50 km/h (2030 mph).
Driving on dry roads with chains for extended periods of time.
Not securing the chains tightly enough. Manuals recommend that the chains be tightened a second time after driving a short distance, and to check for tightness from time to time. Chains that come loose should be refastened or removed before they wrap around the vehicle's drive axle.
Tensioners or adjusters may be required. (Some tire chains do not require tensioners and may be damaged if tensioners are used.)

### Alternatives

Diamond chains diamond pattern car or truck chains
Link chains same as tire chains or snow chains
Traction cables formed from cable wire instead of chain links
Cable chains Same as traction cables
Snow cables Same as traction cables
Snow tires tires with deep grooves to grab snow to aid traction.
Studded tires snow tires with metal studs used in icy conditions.
Spider shaped chains mounted onto the tires from the side.
Sock fabric rather than chain or cable.
Polyurethane or rubber used instead of a chain.

### Legality of Use

Laws vary considerably concerning the legality of the use of snow chains. Some jurisdictions may require their use in certain weather conditions or during certain months of the year, while other states or jurisdictions may ban their use altogether to preserve the surface of the roads.

Alternatives to snow chains are also known in the art. One such illustrative example may be seen in U.S. Pat. No. 2,765,199, illustrated here on FIGS. 9 and 10 (Prior-art 1), and disclosing, inter alia, “This invention relates generally to vehicle wheel assemblies and is more particularly concerned with a novel antiskid wheel assembly wherein the vehicle upon which the novel assemblies are mounted is readily usable in snow, mud, etc. A primary object of the invention is to provide a novel antiskid wheel assembly including a wheel having a rim supporting thereon a tire assembly; a plurality of radially disposed antiskid lug assemblies reciprocably supported on the wheel rim, the lug assemblies including a friction increasing means on a terminal end portion thereof which may be extended beyond the outer periphery of the tire assembly, and fluid pressure means supported on the wheel and engageable with the lug assemblies effective to overcome spring means associated with the lug assemblies which normally urge the lug assemblies to a retracted position below the outer periphery of the tire assemblies.

“A further object of the invention in conformance with that set forth is to provide in a novel antiskid wheel assembly of the character set forth a fluid pressure means comprising an annular inflatable or collapsible tube which is concentrically disposed within the inner periphery of the wheel rim of the novel wheel assembly, wherein the lug assemblies comprise a plurality of radially disposed support sleeves extending through the rim, said support sleeves reciprocably supporting a support shaft having on one end a friction increasing means extendable beyond the outer periphery of the tire assembly, the other end of said shaft being engageable by the annular force transmitting inflatable tube, said shafts having circumposed about an intermediate portion thereof a compression spring which engages the inner periphery of the wheel rim and a terminal abutment portion on the inner end of the support shaft.”

Another alternative is shown by U.S. Pat. No. 5,788,335, illustrated here as FIGS. 11 and 12 (Prior-Art 2) and disclosing, inter alia, “As shown in FIG. 3, the rim 22 of the traction device 10 is sandwiched between the rims 13 of the inner wheel 14 and outer wheel 12. The rim 13 of the wheels 12, 14 and the rim 22 of the traction device 10 are mounted to the wheel assembly 16 and are secured by the mounting lugs or bolts 15. The traction device 10 is thus rotatable with the wheels 12, 14. The valve stem 28 extends through a conventional opening provided in the rim 13 of the wheels 12. This provides access to the valve stem 28 for inflating and deflating the tire 24 of the traction device 10. As shown in the figure, the tire 24 of the traction device 10 is illustrated in the deflated state (contracted) in solid lines and the tire 24 is shown in the inflated (expanded) state in dashed lines. In the contracted state, the tire 24 has been deflated to contract radially inward and thus the diameter of the tire 24 is less than the diameter of the wheels 12, 14. In the expanded state the tire 24 has been inflated with pressurized air to expand the tire radially to exceed the diameter of the wheels 12, 14.

“The illustration of the tire 24 in the expanded state is exaggerated for illustrative purposes. The tire 24 is expanded such that the studs 20 will extend beyond the diameter of the wheels 12, 14 to engage the supporting surface (roadway). The wheels 12, 14 still supports the vehicle weight and the tire 24 provides the traction.

“Referring to the dashed outline of the tire 24 of the traction device 10 of FIGS. 3 and 4 (which shows the traction device 10 in the expanded state) the tire 24 has been inflated by pressurized air. The tire 24 has expanded radially such that the diameter of the tire 24 is greater than the wheels 12, 14. The studs 20, when the tire 24 is in the expanded state, will extend beyond the diameter of the wheels 12, 14 to engage the roadway R projected through an ice or snow covering S. The studs 20 in engagement with the roadway R will provide the necessary traction required when the vehicle encounters slippery surfaces caused by ice, snow and the like. (The representation of ice/snow covering S and the projection of the studs to the roadway R is illustrative only of the expandability function of the invention and is not intended to accurately depict the manner by which gripping occurs, e.g., the studs in packed snow or ice conditions will not necessarily penetrate through to the bare roadway.)”

It would be desirable to have a mobility device which may be configurable, and may generally designed to be removably mounted on one or more vehicle wheels, and which may be capable of transforming between a position where the mobility enhancing device may have as little as possible impact on a mobility of the vehicle, and a second position, wherein the mobility device may have a considerable impact on the mobility of the vehicle associated therewith. This may be attained with the subject matter in accordance with the claims.

### SUMMARY

In the following disclosure, aspects thereof are described and illustrated in conjunction with systems and methods which are meant to be exemplary and illustrative, not limiting in scope.

According to an aspect of the present disclosure, there is provided a mobility device designed to be installed on a wheel of a vehicle comprises a device body extending longitudinally along a wheel axis and having a mechanism. The mechanism being provided with a scroll plate extends generally radially and having opposing inner and outer plate faces, and a plurality of stakes each extending generally radially away from a hub. The scroll plate comprises at least one spiral groove formed therein, the spiral groove being associated with, and driving the plurality of stakes, to reciprocably extend and/or retract generally radially relative to the device body by a pin associated with each of the plurality of stakes and being engaged by the spiral groove of the scroll plate.

According to another aspect of the present disclosure, an exemplary method for enhancing mobility of a vehicle, the method comprising the steps of providing mobility device designed to installed on a wheel of a vehicle comprises a device body extending along a wheel axis and comprising a mechanism; providing an adaptor mounted upon a vehicle axis to facilitate removable installation of the mobility device to the axle; providing the mechanism with a scroll plate extending generally radially and having opposing inner and outer plate faces, and with a plurality of stakes each extending generally radially away from a hub; providing the scroll plate with a spiral groove formed therein; providing a plurality of stakes each being retractably extensible generally radially relative to the device body; providing each one of the plurality of stakes with a pin associated with each of the plurality of stakes; engaging each pin with the spiral groove of the scroll plate; and rotating the scroll plate relative to the device body to retractably extend the plurality of stakes by driving each pin engaged by the spiral groove. In addition to the exemplary aspects and embodiments described above, further aspects and embodiments will become apparent by reference to the figures and by study of the following detailed descriptions.

### BRIEF DESCRIPTION OF THE DRAWINGS

Exemplary aspects and/or embodiments of the present disclosure will be presented herein below, by way of example only, with reference to the figures.

The figures are generally schematic and/or illustrative in nature, and are not necessarily shown to scale or in actual proportion. Some features may be exaggerated or minimized and/or roughly shown and/or omitted entirely, to show details of particular components. The figures are intended to assist in more fully understanding the detailed description only, to be considered illustrative rather than restrictive, and are not intended to impose, or suggest, any limitation on the spirit and scope of the present disclosure, as defined by the appending claims. In the accompanying schematic illustrations:

FIG. 1 is a schematic perspective illustration of an exemplary embodiment of the mobility device, showing an outer flank thereof, with a plurality of stakes in a converged state;

FIG. 2 depicts a schematic, perspective illustration of the mobility device of FIG. 1, showing an inner flank thereof;

FIG. 3 schematically illustrates an outer exploded perspective view of the mobility device shown on FIG. 1;

FIG. 4 illustrates schematically another exploded perspective view of the mobility device shown on FIG. 1, this time from an inner viewpoint;

FIG. 5 schematically illustrates an outer perspective view of one of the plurality of stakes of the mobility device shown on FIGS. 1 and 2;

FIG. 6 illustrates, schematically, an inner perspective view of a scroll plate of the mobility device shown on FIGS. 1 and 2, with two of the plurality of stakes (one such stake is shown on FIG. 5) in a fully deployed state;

FIG. 7 schematically depicts an outer perspective view of an inner cup of the mobility device shown on FIGS. 1 and 2, and with two of the plurality of stakes shown on FIG. 6) in the frilly deployed state;

FIG. 8 schematically illustrates an inner perspective view of the mobility device shown on FIGS. 1 and 2, assembled upon an associated wheel (of a vehicle, not shown) with the plurality of stakes shown in the fully deployed state;

### DETAILED DESCRIPTION

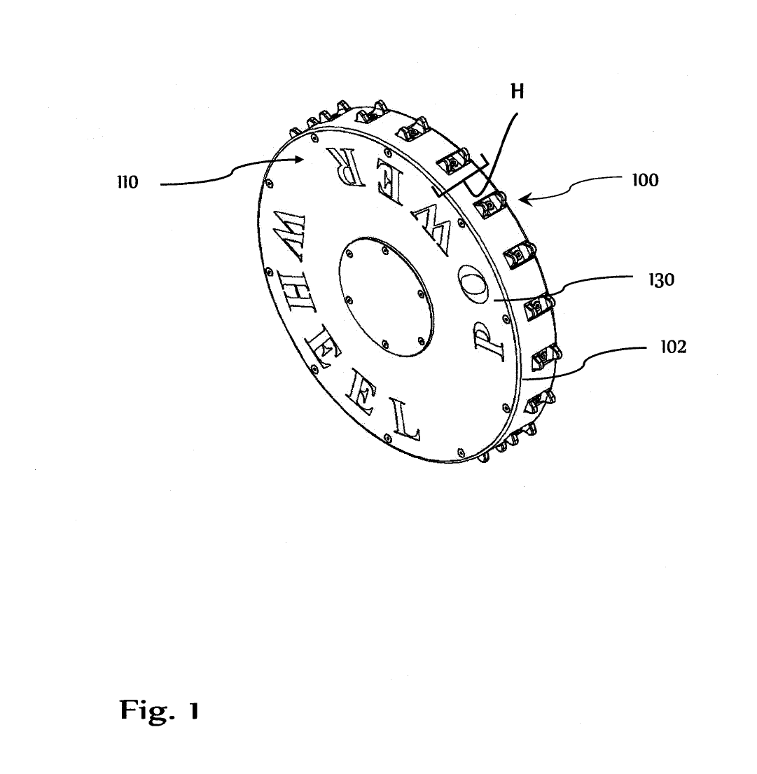

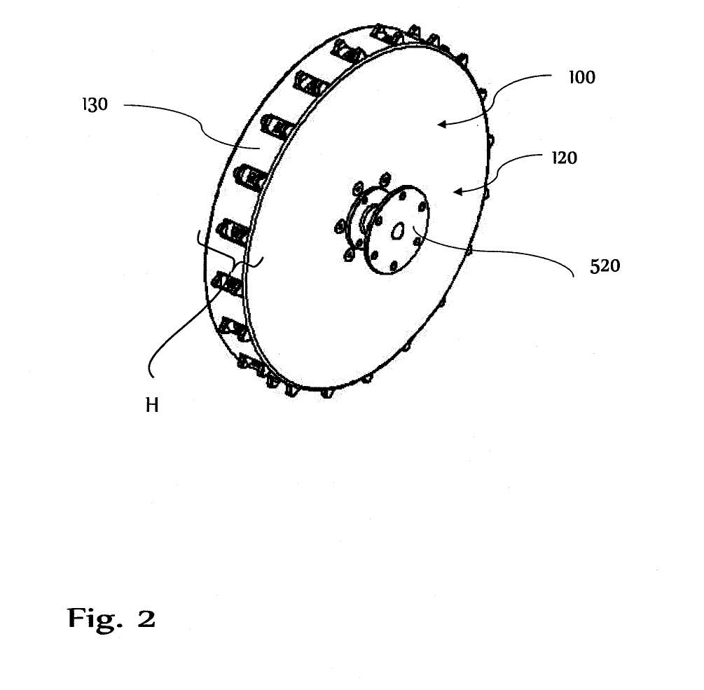

Attention is presently drawn to the figures. FIGS. 1 and 2 show an outer and an inner perspective view, respectively, of a mobility device 100. The term “outer” generally relates to a direction away from, while “inner” generally relates to a direction towards, a body (not shown) of a vehicle (not shown). The mobility device 100 has a generally cylindrically shaped device body 102 extending to an external radius R about a longitudinal axis L extending along a wheel axis. Parallel circular outer base 110 and an inner base 120 define a height H extending therebetween along the longitudinal axis L.

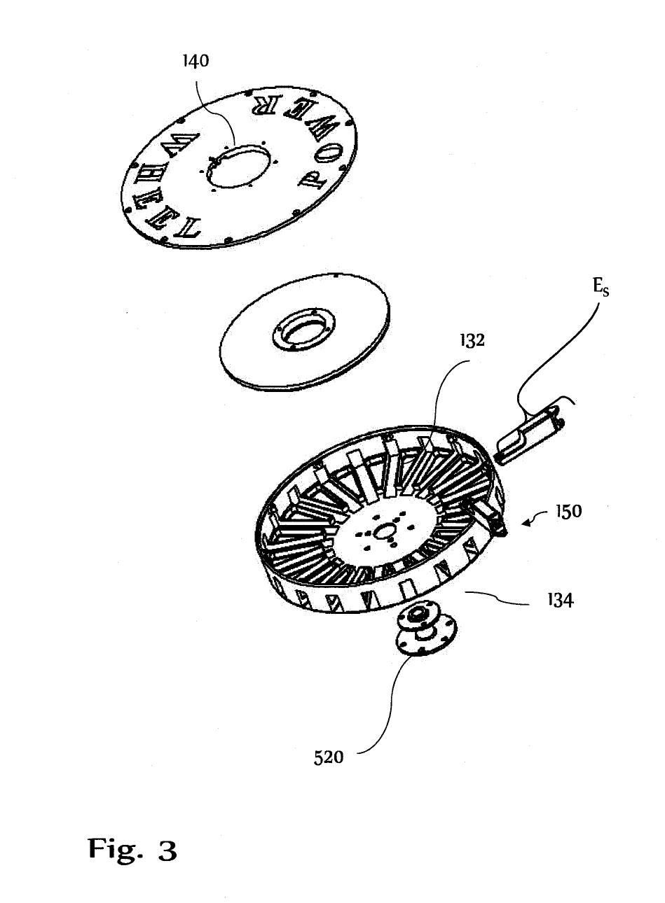

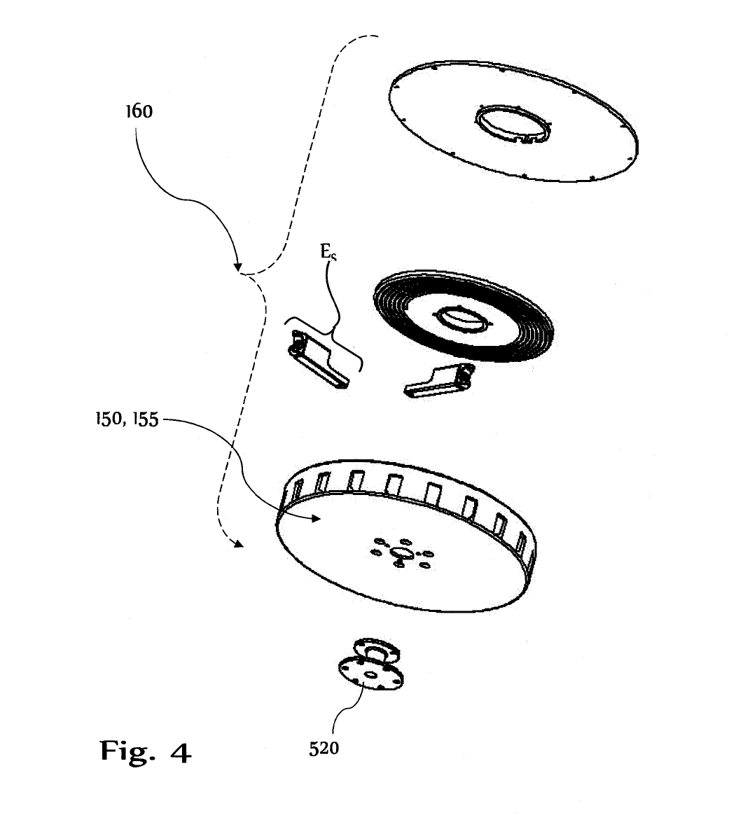

Attention is further directed to FIGS. 3 and 4. The height H may be considerably shorter than the external radius R of the device body 102, which further comprises a generally cylindrical apron 130 having a generally radially inwardly facing inside periphery 132 and an opposing, generally radially outwardly facing outside periphery 134. The outer base 110 comprises a cover 140, while the inner base 120, together with the apron 130 which may be integrally formed and/or removably assembled therewith, define a cup 150. The cup 150 and the cover 140 comprise a casing 155 which may accommodate a mechanism 160.

Attention is presently directed to FIG. 6. The mechanism 160 comprises a scroll plate 170 extending generally radially, parallel to outer base 110 and the inner base 120 and disposed generally therebetween. The scroll plate 170 comprises an inner plate face 210 and an outer plate face 215 extending generally parallel thereto. The mechanism 160 further comprises a plurality of stakes 180. The mechanism 160 allows the plurality of stakes 180 to retract so that when retracted a significant portion of a stake extent E_{S} may be accommodated within the device body 102.

The scroll plate 170 extends generally radially outwardly from a plate center 240 to a plate periphery 260. The scroll plate 170 may comprise at least one spiral groove 200 formed on the scroll plate 170, sunken axially away from the inner plate face 210 thereof. The at least one spiral groove 200 may be continuous, extending from a groove start 230 adjacent the plate center 240 and spiraling out, or progressing generally radially outwardly as the at least one spiral groove 200 advances generally tangentially, to a groove end 250 adjacent the plate periphery 260, to define a spiral-out direction S_{OD} of a rotation of the scroll plate 170. The spiral groove 200 may comprise a plurality of groove wraps 202, of which there may comprise a generally centrally disposed, inner wrap 204 and a peripherally outwardly disposed outer groove wrap 206.

The at least one spiral groove 200 may be closed, for example by a first wall 270 adjacent a first end 280 and by a second wall 290 adjacent a second end thereof. The first wall 280 and the second wall 290 may extend generally transversely away from a groove floor 300 to the inner plate face 210. Generally, the at least one spiral groove 200 dips below the inner plate face 210, but optionally may not penetrate through the spiral plate to open onto the outer plate face 215. Potentially, the at least one spiral groove 200 may be further bounded by a curved inner flank 310 facing generally radially peripherally and by a curved outer flank 320 facing generally radially centrally. Optionally, the inner flank 310 and the outer flank 320 define a gap 330 therebetween. Possibly, there may be formed on the scroll plate 170 a plurality of spiral grooves 200. In such a case, the plurality of spiral grooves may nest therebetween.

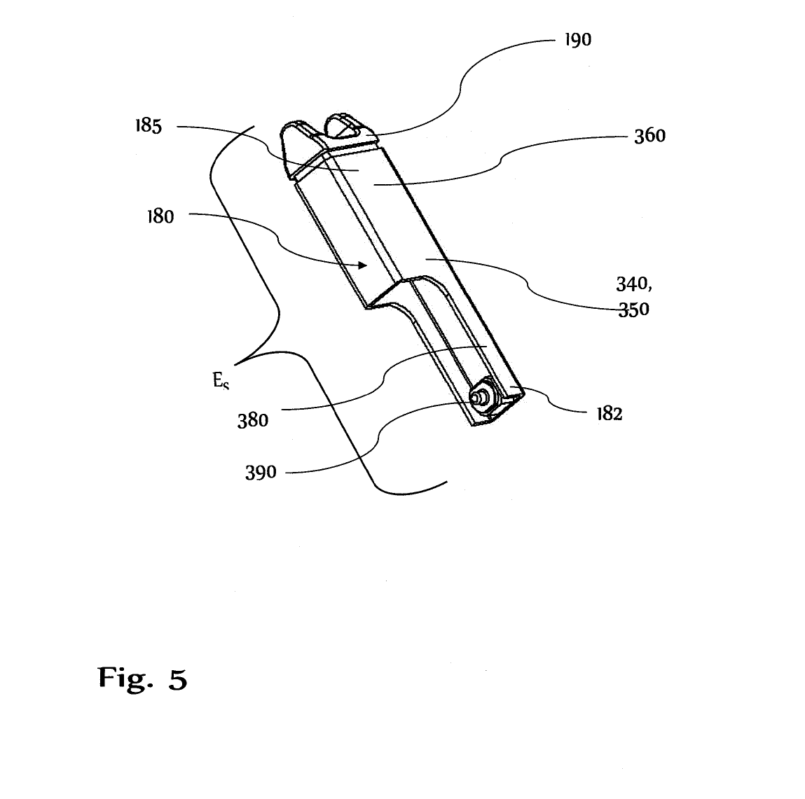

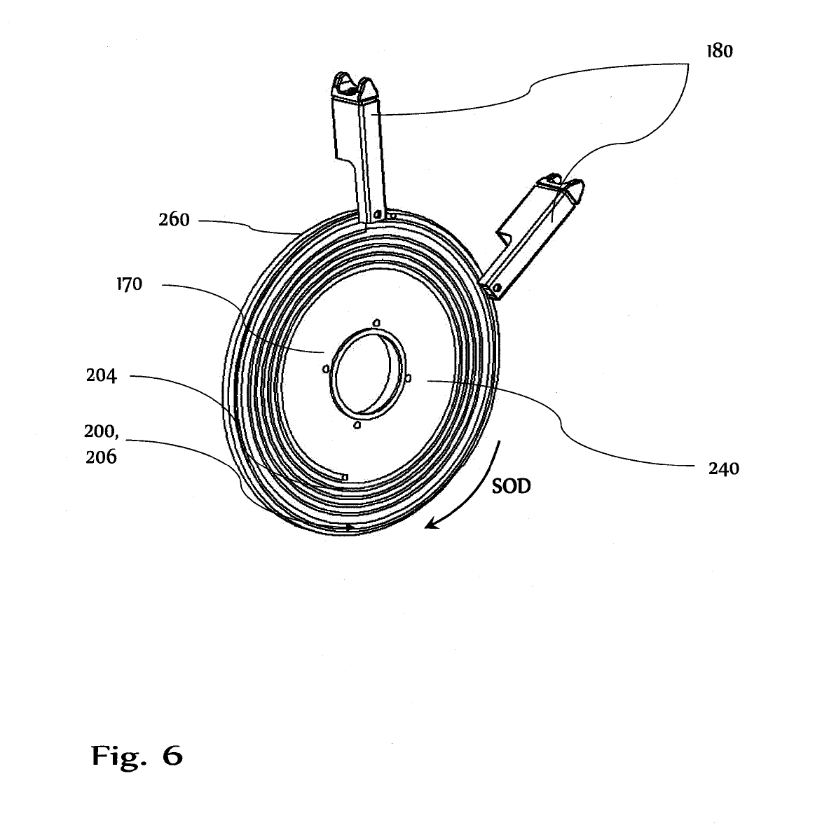

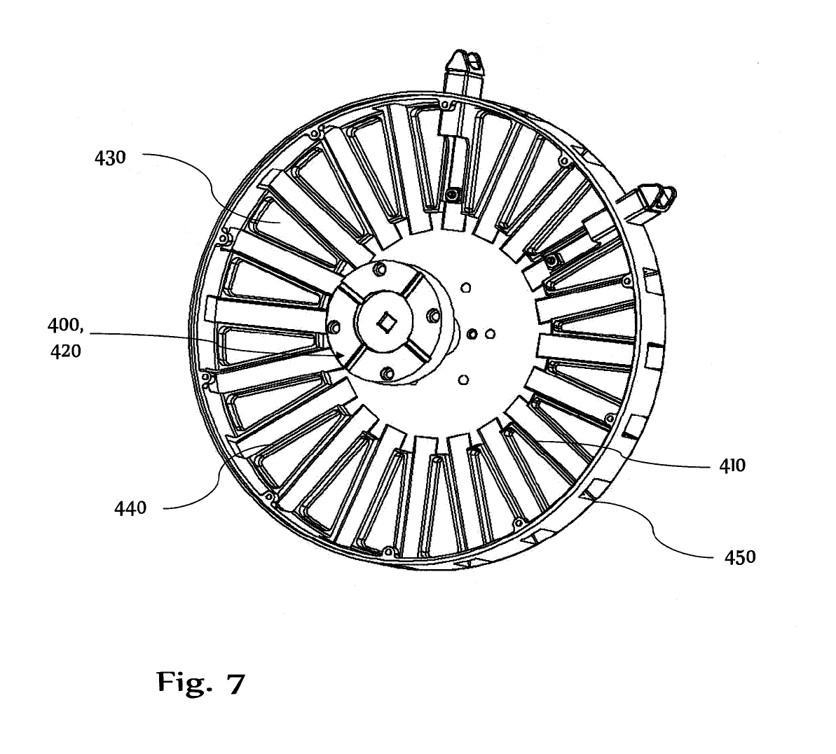

Attention is presently directed to FIG. 5. Each of the plurality of stakes 180 comprises a stake body 340 extending generally radially outwardly to the stake extent Eₛ from a stake start 182 to a stake end 185 through a stake middle portion 350. A stake peripheral portion 360 extends from the stake start 182 to the stake end 185. The stake body 340 further extends generally radially inwardly away from the stake end 185, along the stake middle portion 350 to the stake central portion 380 terminating in a stake root 385 adjacent the plate center 240.

Optionally, the stake end 185 may comprise the stake shoe 190. The stake body 340 may be generally manufactured from any known or discovered tough, strong, and/or rigid yet durable composition, including as an illustrative example only, but not limited to, known and/or discovered type and/or alloy of steel, aluminum, titanium, and/or composites such as, but not limited to, carbon-fiber composites and/or other similar compositions. The optional stake shoe 190 may be manufactured of any known or discovered resilient and/or tough and/or durable material, including as an illustrative example only, but not limited to, any rubber or synthetic material and/or hard and tough compounds (such as, but not limited to, carbides, ceramics, ceramic-metallic compositions, metal-matrix composites, and/or alloys). The optional stake shoe 190 may be detachably associated with the stake end 185 of the stake body 340 to facilitate replacement thereof.

The stake central portion 380 may comprise an upstanding pin 390 protruding axially outwardly away from the stake body 340. Location of each of the pins 390 on its associated one of the plurality of stakes 180 may vary along the stake extent Eₛ. The pin 390 associated with each of the plurality of stakes 180 may extend axially away from the stake body 340. The pin 390 may slidingly fit within the gap 330 of the spiral groove 200. Optionally, the pin 390 may be detachably secured to the stake body 340, to facilitate adjustment.

Attention is presently drawn to FIG. 7. The plurality of stakes 180 may cooperate with the inner base 120. An outer face 400 of the inner base 120 may comprise a plurality of generally triangular, raised sections 410 extending away from an outer face center 420 to an outer face periphery 430 adjacent the apron 130. Separating each two adjacent raised sections 410 is a chasm 440 extending generally radially away from the face center 420 towards the apron 130 to terminate in a breach 450 extending through the apron 130. The breach 450 connects the inside periphery 132 and the outside periphery 134 of the apron 130. Each one of the chasms 440 is associated with, and accommodates, one of the plurality of stakes 180. Each one of the plurality of stakes 180 may converge and/or deploy through the associated breach 450.

Relating now to FIGS. 3 to 7, the scroll plate 170 may be assembled to the mobility device 100 with the at least one spiral groove 200 facing the outer face 400. Pins 390 of the plurality of stakes 180 may be accommodated by, and distributed along, the at least one spiral groove 200. Optionally, the pins 390 of a majority of the plurality of stakes 180 may be accommodated by, and distributed about the inner groove wrap 204. When more than one spiral groove 200 are formed on the scroll plate 170, different pins 390 associated with different stakes 180 may be accommodated by, and distributed along, different spiral grooves 200. Optionally, alternating pins 390, associated with alternating stakes 180, may be accommodated by, and distributed along, alternating spiral grooves 200, generally meaning that different but adjacent pins 390 may be accommodated by different, but adjacent, spiral grooves 200.

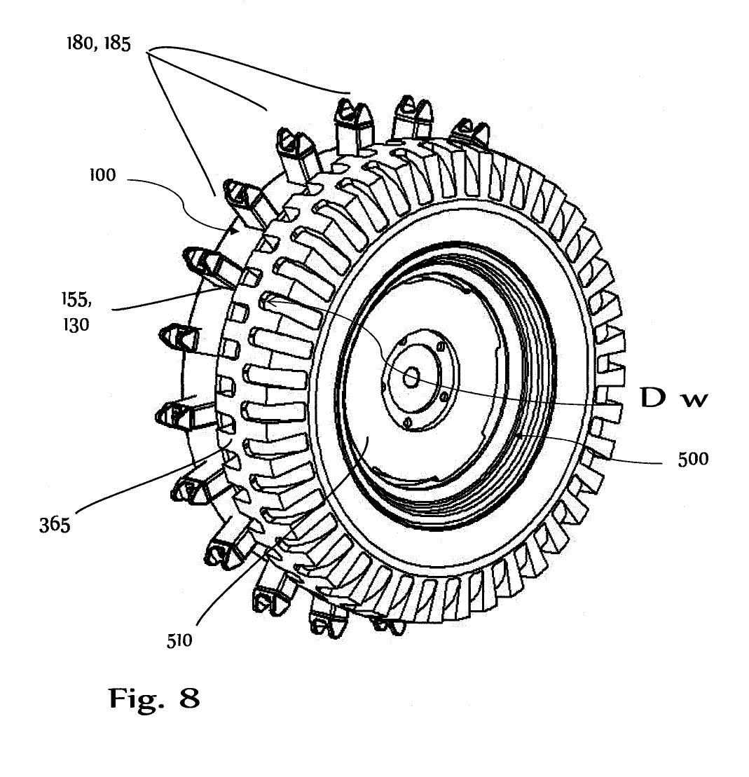

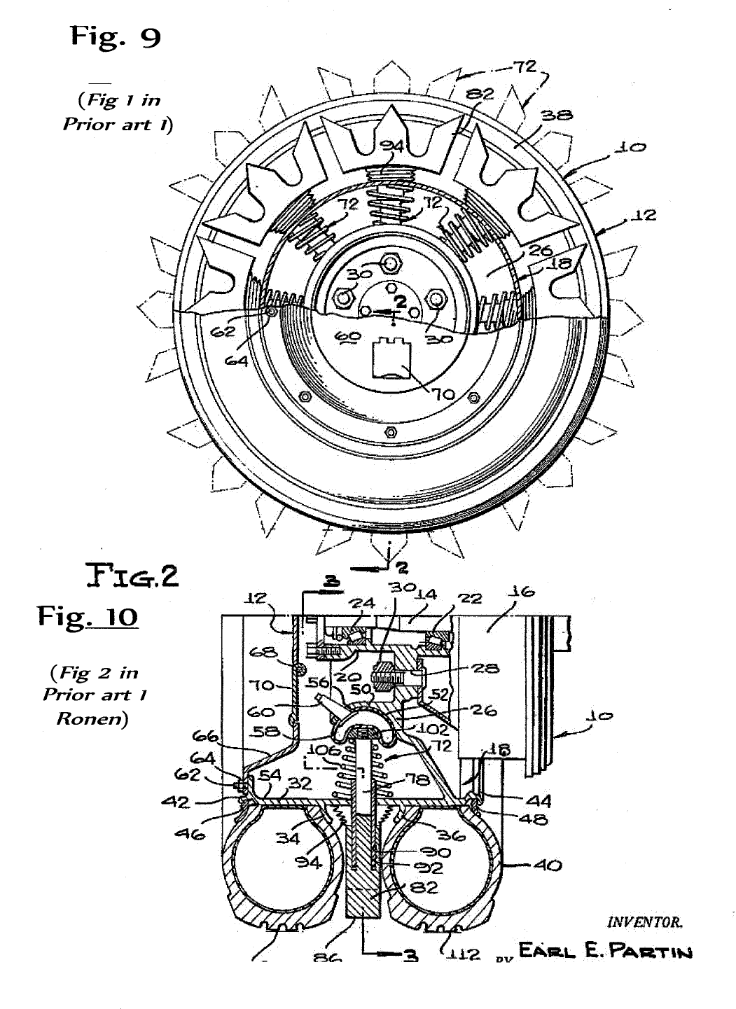

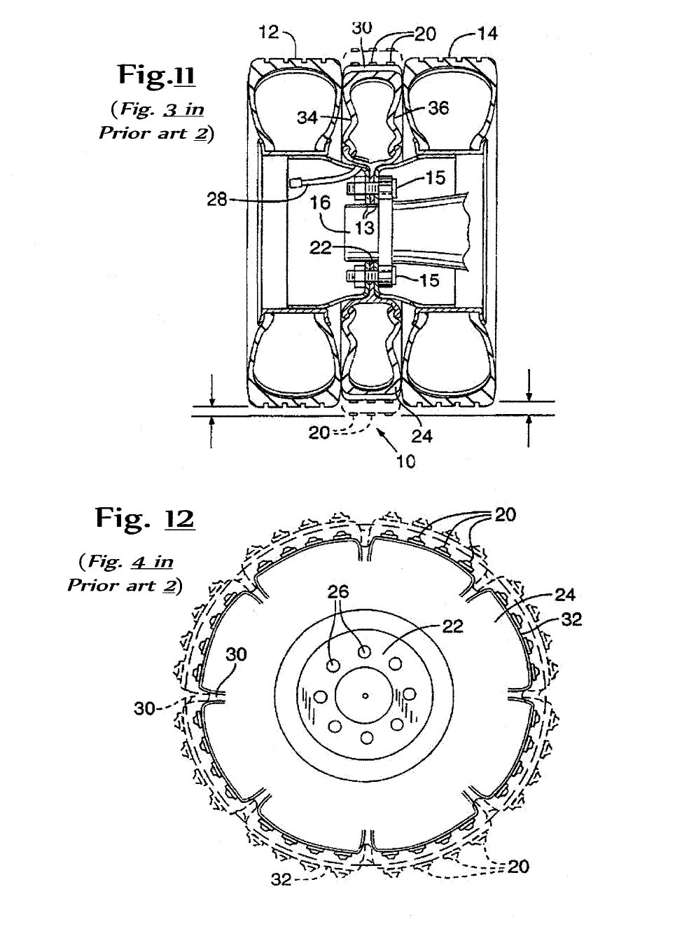

Attention is presently drawn to FIG. 8. The mobility device 100 may be generally associated with a vehicle wheel 500. The wheel 500 may be a single wheel (one wheel mounted upon an end of an axle, not shown) or a dual wheel (two adjacent wheels mounted upon the end of the axle, not shown). With a single wheel, the mobility device 100 may be associated with an outer wheel side 510 (as may be seen on FIG. 8) and/or on an inner wheel side (not shown), and/or two mobility devices 100 may be associated with each of the inner and outer sides of each wheel (not shown). With a dual wheel (see, as illustrative-only, non-limiting examples, U.S. Pat. No. 4,220,372, U.S. Pat. No. 2,132,029), there may be associated one mobility device 100 on either the inner or outer side of the dual wheel (not shown) or between an inner and outer wheel of the dual wheels (not shown). Alternatively, up to three mobility devices may be associated with the dual wheel.

As an illustrative only, non-limiting in scope and/or spirit example, FIG. 8, schematically illustrating the mobility device 100 associated with the outer side opposite an inner side 510 of the vehicle wheel 500, will be discussed herein below. However, alternatives as disclosed in the paragraph above may be obvious to a person versed in the art. The mobility device 100 may be associated with the wheel 500 by means of an adapter 520 (may be seen on FIGS. 3 and 4). The adapter 520 may removably connects the cup 150 to the outer side 510 of the associated wheel 500.

Attention is currently directed to FIGS. 5 to 12. When the mobility device 100 is removably mounted on the associated wheel 500, it is in a first, or converged, state. In the converged state, the plurality of stakes 180 are converged inside the casing 155, either entirely or leaving a generally radially peripheral zone 365 adjacent the stake end 185 to project generally radially away through the apron 130 and away from the outside periphery 134 of the casing 155, to a diameter smaller than a wheel external diameter D_{W}. The scroll plate 170 may be rotated in the spiral-out direction S_{OD}, to urge each of the plurality of pins 390 and, with these, each of their respective, associated stakes 180 gradually towards a second, or fully deployed, state. The deployed state may be considered any state of the mobility device 100 in which each of the plurality of stakes projects beyond the wheel external diameter D_{W}. Deployment may vary from a minimal deployment, in which the plurality of stakes 180 may project only partially away or beyond the wheel external diameter D_{W} to a full extension thereof

Prior to deployment of the mobility device 100, at least one adaptor 550 (see FIGS. 3 and 4) may be mounted upon an axle (not shown) on which the associated wheel 500 may be located. Although the particular at least one adaptor 520 is shown as if it may be removably mounted on an outer side opposite the inner side 510, other embodiments may be removably mounted on the axle (not shown) at an inner side 510. With dual wheels, as an illustrative, nonbinding example, various embodiments of similar adaptors, as may be obvious to a person versed in the art, may be removably mounted on either the outer side, the inner side, and/or between the dual wheels (not shown).

When driven on a road not requiring enhanced mobility, the vehicle (not shown) may be driven with only the at least one adapter 550 removably mounted on the associated wheel 500. With the at least one adaptor 550 mounted on the associated wheel 500, the vehicle (not shown) may be driven substantially normally.

Prior to going off-road, particularly where traction requirements may exceed what regular tires may provide, at least one mobility device 100 may be installed upon a corresponding at least one adaptor 550. Installation may commence with the mobility device 100 in a first, or converged state, wherein the plurality of stakes 180 are accommodated mostly within the casing 155 with most of the stake extent E_{S} inside the apron 130, as may be seen in FIGS. 1 and 2 (albeit without the associated wheel). Installation of the at least one mobility device 100 may be facilitated by the at least one mobility device 100 having a converged diameter smaller than the wheel external diameter D_{W}, so that installation may commence without requiring any lifting facilities, such as, but not limited to, jacks.

Upon embarking off-road, or when increased traction may be called for, the at least one mobility device may be deployed by extending the plurality of stakes 180 so that at least the stake peripheral portion 360, terminating in the stake shoe 190, projects generally radially outwardly beyond the wheel external diameter D_{W}.

Deployment, or extension of the plurality of stakes 180, of the mobility device 100, is facilitated by rotation of the scroll plate 170 relative to the cup 150 in the spiral-out direction S_{OD} from a converging stance to an extending stance. In the converging stance, the majority of the plurality of stakes 180 may be accommodated by, and distributed about the inner groove wrap 204, while in the extending stance, optionally a different majority of the plurality of stakes 180 may be accommodated by, and distributed about the outer groove wrap 206 (potentially because the outer length of the outer groove wrap 206 is larger than the inner length of the inner groove wrap 204). Depending upon how much added traction may be desired, deployment may gradually vary from a minimal deployment, in which only the stake ends 185 of the plurality of stakes 180 projects beyond the wheel external diameter D_{W}, to a maximal deployment.

Rotation may be facilitated in several alternative and/or combined manners of any applicable, known and/or discovered means, such as, but not limited to, manually (for example, by an external, handheld crank) electrically (as a nonbinding example, by an electric motor and any known and/or discovered drive means) or hydraulically and/or pneumatically, to name a few illustrative examples.

In case that a higher density of stakes may be called for, more than one spiral groove 200 may be formed on the scroll plate 170. In such designs, the spiral grooves may interfit one within the other, and the plurality of stakes may be arranged so that if one of the stakes is associated with one of the spiral grooves, the following one of the stakes will be associated with a second spiral groove.

While a number of exemplary aspects and embodiments have been discussed above, those of skill in the art will recognize certain modifications, permutations, adaptations, additions and/or sub-combinations thereof It is therefore intended that the follow appended claims and claims hereafter introduced be interpreted to include all such modifications, permutations, additions and sub-combinations as are within their true spirit and scope. Such exemplary modifications, permutations, adaptations, additions and/or sub-combinations may include, but are not limited to, variations of the construction of the stakes, the pins, the number of spiral grooves, pitch of the spiral groove, and/or construction and attachment details of the mobility device.

To provide some illustrative, nonbinding and/or non-limiting examples, variations, modifications, permutations, adaptations, additions and/or sub-combinations may include inverting the direction the scroll plate is installed in the mechanism, a spiral through-groove formed in the scroll plate, installing the pin of any of the plurality of stakes as a simple beam supported between split stake ends, and other variations, modifications, permutations, adaptations, additions and/or sub-combinations which may be obvious to a person skilled in the art.

It is to be understood some features are shown or described to illustrate the use of the present disclosure in the context of functional elements and such features may be omitted within the scope of the present disclosure and without departing from the spirit of the present disclosure as defined in the appended claims.

All directional references (such as, but not limited to, inner, outer, axial, radial, center and/or central, periphery and/or peripheral, upper, lower, upward, downward, left, right, leftward, rightward, top, bottom, above, below, vertical, horizontal, clockwise, and counterclockwise, tangential, axial and/or any other similar references) are only used for identification purposes to aid the reader's understanding of the embodiments of the present disclosure, and may not create any limitations, particularly as to the position, orientation, or use unless specifically set forth in the claims.

Similarly, joinder references (such as, but not limited to, attached, coupled, connected, and the like) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

Similarly, adjectives such as, but not limited to, “articulated”, “modified”, or similar, should be construed broadly, and only as nominal, and may not create any limitations, particularly as to the description, operation, or use, unless specifically set forth in the claims.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

1. A mobility device designed to be removably installed to a wheel of a vehicle comprises a device body extending longitudinally along a wheel axis and having a mechanism, the mechanism being provided with a scroll plate and a plurality of stakes, each of the plurality of stakes extending generally radially away from a hub, the scroll plate being rotatable relative to the body, extending generally radially away from the wheel axis, and having at least one spiral groove formed thereon, the spiral groove being associated with and driving the plurality of stakes to retractably extend generally radially relative to the device body.

2. The mobility device of claim 1, wherein the scroll plate comprises at least two spiral grooves formed therein.

3. The mobility device of claim 2, wherein the at least two spiral grooves nest therebetween.

4. The mobility device of claim 1, wherein the at least one spiral groove is formed on an inner plate face of the scroll plate.

5. The mobility device of claim 1, wherein the at least one spiral groove is formed on an outer plate face of the scroll plate.

6. The mobility device of claim 1, wherein the plurality of stakes are driven to retractably extend by a pin associated with each of the plurality of stakes and being engaged by the spiral groove of the scroll plate.

7. The mobility device of claim 1, wherein the plurality of stakes are driven to retractably extend through an associated breach in the device body.

8. A method for enhancing mobility of a vehicle, the method comprising the steps of:
a. providing mobility device designed to installed on a wheel of a vehicle comprises a device body extending along a wheel axis and comprising a mechanism;
b. providing an adaptor mounted on a vehicle axis to facilitate removable installation of the mobility device to the axle;
c. providing the mechanism with a scroll plate extending generally radially and having opposing inner and outer plate faces, and with a plurality of stakes each extending generally radially away from a hub;
d. providing the scroll plate with a spiral groove formed therein;
e. providing a plurality of stakes each being retractably extensible generally radially relative to the device body;
f. providing each of the plurality of stakes with a pin associated with each of the plurality of stakes;
g. engaging each pin by the spiral groove of the scroll plate; and
h. rotating the scroll plate relative to the device body to retractably extend the plurality of stakes by driving each pin engaged by the spiral groove.
